(19) United States
(12) Patent Application Publication
(10) Pub. No.: US 2022/0258546 A1
(43) Pub. Date: Aug. 18, 2022

(54) Tires with Intrinsic Cellular Noise Damper

(71) Applicant: Triangle Tyre Co. Ltd., Weihai (CN)

(72) Inventors: Ramendra Nath Majumdar, Hudson, OH (US); Wang Dapeng, Weihai City (CN)

(21) Appl. No.: 17/176,005

(22) Filed: Feb. 15, 2021

(51) Int. Cl. B60C 19/00; B60C 1/00; B29D 30/06

(52) U.S. Cl. CPC B60C 19/002; B29D 2030/0682; B29D 30/0681; B60C 1/0008

(57) ABSTRACT

A tire with intrinsic splice-free cellular noise damper comprising a supporting tire carcass having one or more layers of ply, an outer circumferential tread, and a radially inner layer, a pair of beads, sidewalls extending radially inward from the axial outer edges of a tread portion to join the respective beads, an intrinsic cellular noise damper as the innermost layer attached to innerliner, wherein said noise damper has a density less than 1.3 g/cm3.

### BACKGROUND OF THE INVENTION

The present invention is directed to tires having inner cellular layer that is formed from cellular precursor layer containing blowing agent or agents in situ during tire curing step.

Tires consist of multiple annular layers of different compounds, plies, belts, etc., and they are applied before the curing process in the building drum for accurate alignment and for higher interlayer bond strengths. Joining and aligning layers before cure results in tires with better uniformity and durability.

Low density cellular polyurethane layers are present in many commercial tires to reduce cabin noise for comfort of the occupants of the vehicle. The density of cellular material inside tire should preferably be low e.g. lower than 0.12 g/cm³. If density is higher than 0.12 g/cm³, then it will lead to higher tire weight which translates to higher rolling resistance causing lower fuel economy and generation of higher greenhouse gases resulting in global warming. Many recent world calamities are blamed to global warming and several countries are working in concert to reduce greenhouse gas emissions. The cellular layer should have density higher than 0.02 g/cm³, otherwise the material will have very low tear strength and may easily tear during application or during tire use.

Literature and some commercial tires examined e.g., Michelin tire equipped with Acoustic Tech, Goodyear tire equipped with SoundComfort™ Technology, etc. have annular low density cellular polyurethane attached inside cured tire and the ends are joined by an adhesive. Cellular polyurethane cannot survive tire curing conditions and hence need to be applied after the tire is cured. If cellular polyurethane is applied before tire is cured, then it will get flattened and will lose all sound absorption properties. Shortcomings of applying cellular layer after tire cure which can potentially be eliminated by applying cellular layer or cellular precursor layer before a tire is cured.

The way most tires are manufactured, the innerliner is often contaminated by residual silicone based inside tire paint or tire curing bladder lube. Most adhesives do not bond well to silicone contaminated rubber surface. Cleaning inside tire is cumbersome and time consuming and often environmental polluting solvents are needed for better cleaning. Buffing of innerliner is also used to clean innerliner which is also cumbersome. Some adhesives like silicone adhesive bonds to silicone contaminated innerliner surface but better bonding can be achieved by cleaning the innerliner and use of different kinds of adhesive. Alternatively, special manufacturing techniques are available which will keep innerliner clean e.g., U.S. Pat. No. 7,332, 047 to Majumdar et al. and U.S. Pat. No. 10,632,799 to Majumdar.

Ends of annular foams inserted inside cured tire are attached by an adhesive. End-to-end foam joining can be eliminated by applying foamable liquid inside cured tire onto tire innerliner. Bond strength of innerliner-to-cellular layer is usually weak due to absence of interlayer crosslinking. So, the cellular layer application is limited to underneath tread and they likely to separate if applied also in the sidewall area due to high flexes in that region of the tire. Inserting and aligning cellular layer inside tire is significantly more cumbersome than applying before cure particularly in tire building drum. Tire building drums are equipped with laser guidance to align layers in order to prevent balance issues after curing the tire.

Cellular material can be applied to green tire and this is a significant achievement as it eliminates the need of tire cleaning steps. One example is application of low density silicone foam (0.1 g/cm³) which survives tire cure conditions and this technology is reduced to practice. Lower density silicone foams e.g., 0.03 g/cm³ can also be used when such foam is readily available in the market. Rubber-based cellular precursor was also tried by laying inside green tire (U.S. Pat. No. 7,694,707 and USPA 2007/0137752 A1). Density of cellular material formed as a function of content of blowing agent is shown in FIG. 1 (using data from U.S. Pat. No. 7,694,707). Blowing agents are chemicals that form gases when decomposed under heat and used for manufacturing cellular materials. Blowing agents are available commercially and well known to those familiar with the art. U.S. Pat. No. 7,694,707 taught that density of cellular material reduces with increasing blowing agent concentration. US '707 also taught that to get density of 0.28 g/cm³, need 25 phr of blowing agent. Extrapolation of US '707 indicates that extremely high concentration of blowing agent is needed to get lower density cellular layer of practical significance, i.e., 0.12 g/cm³. Consistent with US '707, U.S. Pat. No. 8,978,721 used 50 phr blowing agent (Azodicarbonamide) and still could not get density of 0.12 g/cm³ or lower. Suitable technology to generate low density cellular layer using reasonable amount of blowing agent, say less than 25 phr, so that it helps in tire cavity noise reduction without increasing tire weight is highly desired in the tire industry.

### BRIEF SUMMARY OF THE INVENTION

The invention relates to a tire with intrinsic splice-free cellular noise damper comprising a supporting tire carcass having one or more layers of ply, an outer circumferential tread, and a radially inner layer, a pair of beads, sidewalls extending radially inward from the axial outer edges of a tread portion to join the respective beads, an intrinsic cellular noise damper as the innermost layer attached to innerliner, wherein said noise damper has a density less than 1.3 g/cm3.

The invention further relates to a method for making a tire having a foam noise damper, the method comprising the steps of: applying at least one layer of noise damper precursor containing less than 20 phr blowing agent to a tire building drum, wherein the ends of the noise damper precursor are first overlapped and then stitched together; applying an innerliner and then other layers commonly used in building pneumatic tires, expanding and shaping the tire, removing from tire building machine; and curing the tire in a tire press.

### BRIEF DESCRIPTION OF DRAWINGS

The foregoing and other features and advantages of the present invention will become apparent to those skilled in the art to which the present invention relates upon reading the following description with reference to the accompanying drawings, in which:

FIG. 1 is a chart of prior art data showing the density of cellular material formed as a function of content of blowing agent;

FIG. 2 shows a green tire changing to cured tire;

FIG. 3 is an expanded view of a portion of cured tire of FIG. 2 showing interfacial bonding between the cellular layer and tire innerliner;

FIG. 4 shows a cured tire build using one layer of cellular precursor overlapping at the end showing visible non-uniformity in cellular layer; and

FIG. 5 is a cross section of laminate of innerliner, foam precursor with multiple holes and foam precursor without holes.

### DETAILED DESCRIPTION OF INVENTION

Ultimate goal for tire manufacturers, like most other annular layers, is to apply cellular precursor or low density cellular layer in tire building drum so that low density (less than 1.2 g/cm³) cellular material is attached to innerliner inside cured tire which has not been hitherto achieved. Property requirements for applying cellular material or precursor to cellular material in tire building drum is more stringent than application in green tire. For example, the material must be stretchable in all directions without tearing during the formation of green tire. The material must also have good tack-to-self and to innerliner so that the cellular precursor remains attached during expansion step of green (uncured) tire manufacturing. After cure, the cellular material must bond well to tire innerliner so that they do not fall off during tire use. E.g., cellular silicone rubber can be applied in green tire but the material does not have enough ability to stretch to survive expansion in tire building drum. Inventors of U.S. Pat. No. 7,694,707 applied precursor of cellular rubber in green tire and not in tire building drum (see examples 2 and 3 in the '707 patent). Inventors of U.S. Pat. No. 8,978,721 applied foam precursor containing 50 phr blowing agent in tire building drum and yet could not get density 1.2 g/cm³ or lower. The instant patent application is directed to cellular precursor which can be applied in tire building drum and forms low density sound absorbing foam with strong bonding to innerliner during the tire curing steps using reasonable amount and combination of blowing agents (<20 phr) to get foam density lower than 0.12 g/cm³. As used herein, “cellular” layer is also called “foam” layer which can be used interchangeably.

Three compositions mixed are shown in Table 1 (similar as U.S. Pat. No. 7,694,707 except that N660 is replaced by Ashbury 3772 or Hi-Black 420B). Densities obtained in metal mold are respectively 0.1118 g/cm³, 0.1118 g/cm³, 0.1118 g/cm³ which was significantly lower than US '707 (0.49 g/cm³ with 15 phr blowing agent). Next, bladder molding was tried with smooth side of bladder touching innerliner and again density of cellular layer obtained was significantly lower than in U.S. Pat. No. 7,694,707 particularly with compound 6C027B where density was 0.11 g/cm³. Next, bladder molding was tried with embossed side of bladder touching the rubber (lab simulated tire cure) and density of foam obtained with 7C026A is 0.15 g/cm³ which was significantly lower than previously achieved (US '707). In the case of compound 6C033C, density of cellular rubber obtained in metal mold and in lab simulated tire cure conditions are respectively 0.1012 g/cm³ and 0.52 g/cm³ thus indicating that density of cellular material formed is extremely sensitive to cure conditions. Table 1 shows by replacing carbon black in US '707 with more conductive filler like Ashbury 3772 or Hi-Black® 420, resulting cellular material density can be reduced 77% (0.49 g/cm³ vs 0.11 g/cm³).

TABLE 1
Four foam precursor formulations and comparison of foam density
on curing inside a metal compression mold and bladder mold

| | 6C027A | 6C027B | 6C033C |
|---|---|---|---|
| 1^{st} Pass | | | |
| Bromobutyl 2222 | 100 | 90 | 100 |
| Ionic Butyl I4564P | 0 | 10 | — |
| Naphthenic Oil) | 15 | 15 | 16.5 |
| Ashbury 3772 | 26 | 26 | — |
| Hi-Black ® 420B | — | — | 26 |
| Zinc Oxide | 1 | 1 | — |
| Stearic Acid | 2 | 2 | 2 |
| Koresin | 5.3 | 5.3 | 3 |
| SP1068 | 2 | 2 | 2 |
| 2^{nd} Pass | | | |
| Zinc Oxide | — | — | 1 |
| RM-Sulfur | 0.5 | 0.5 | 0.5 |
| MBTS | 1.24 | 1.24 | 1.3 |
| Celogen OT (OBSH) | 15 | 15 | 15 |

Densities of foam formed inside cylindrical metal compression mold
(diameter = 2.9 cm and height = 1.25 cm) which was 100%
filled with precursor for 20 minutes at 350° F.

| | | | |
|---|---|---|---|
| g/cm³ | 0.1118 | 0.1450 | 0.1012 |

Co-cure in bladder mold with 100 BIIR innerliner compound (6C020A)
for 20 min/350° F./200 psi. Dimensions of foam precursor 2.5″ ×
2.5″ × 0.1″ and 100BIIR innerliner compound = 6″ × 6″ × 0.06″

| Smooth side of bladder | | | |
|---|---|---|---|
| touching rubber | | | |
| Adhesion | Excellent | Excellent | — |
| Foam Density (g/cm³) | 0.167 | 0.11 | — |
| Embossed side of bladder | | | |
| touching rubber | | | |
| Adhesion | Excellent | — | Excellent |
| Foam Density (g/cm³) | 0.15 | — | 0.53 a) |

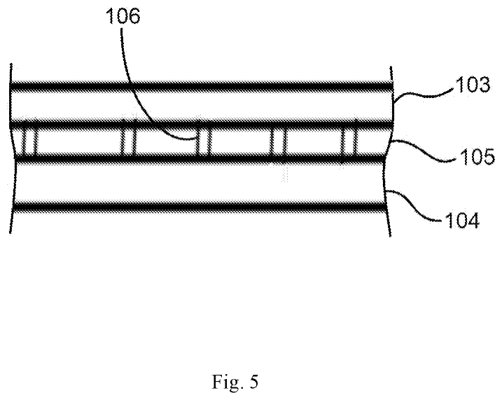

Next, two compositions tried are shown in Table 2 and 7C026A is very similar to US '707 and both contained substantial amount of N660 carbon black. Densities of foam produced are very low in metal mold (100% full) which is still lower when the metal mold is 90% full. During co-cure of innerliner and foam precursor with innerliner in lab simulated tire cure in bladder mold, densities from both 7C026A and 7C026B were high and this was consistent with U.S. Pat. No. 7,694,707. Increasing the thickness of precursor reduces the density somewhat. However, during lab simulated bladder curing, densities were significantly lower when some air pockets were kept for initial expansion. Final expansion occurred when the mold is opened to remove the cured material. This is possible by laminating first an innerliner and then foam precursor with die-punched holes in tandem with calendering, and then foam precursor without hole. Dies were of ¼ inches diameter and separation from centers of each holes were 0.7 inches. Cross section of such laminate is shown in FIG. 5. Foam density can be further reduced by optimizing the volume of initial expansion by controlling the number of holes in the laminate.

Table 1 shows low density foam formation using bromobutyl which has low degree of unsaturation or double bonds. Bromobutyl can be substituted with other rubber of low unsaturation, e.g, chlorobutyl rubber, butyl rubber, halobutyl rubber or ethylene propylene diene monomer (EPDM).

TABLE 2
Mixing and properties of two foam precursor layers

| | 7C026A | 7C026B |
|---|---|---|
| 1^{st} Pass | | |
| Bromobutyl 2222 | 100 | 100 |
| Stanplas 150 | 15 | 15 |
| Conductograph GFCS | — | 15 |
| Sigratherm GFGS | | |
| N660 | 26 | 20 |
| Stearic Acid | 2 | 2 |
| Koresin | 7 | 7 |
| 2^{nd} Pass | | |
| 75% DPG | — | 0.67 |
| Zinc Oxide | 1 | 1.5 |
| RM-Sulfur | 0.5 | 0.5 |
| MBTS | 1.3 | 1.3 |
| OBSH/Celogen OT | 15 | 15 |

Densities of foam formed inside cylindrical metal compression mold
(diameter = 2.9 cm and height = 1.25 cm) which was 100% filled
and then 90% full with precursor for 20 minutes at 350° F.

| | | |
|---|---|---|
| Density when mold 90% Full (g/cm³) | 0.094 | 0.098 |
| Density when mold 100% Full (g/cm³) | 0.113 | 0.128 |

CO-CURE WITH INNERLINER IN BLADDER
MOLD at 350° F./ 200 psi/20 min

| | | |
|---|---|---|
| 1 Layer of Foam Precursor of 3 mm | | |
| thickness | | |
| Foam density of above (g/cm³) | 0.270 | 0.281 |
| 2 Layers of Foam Precursor each of | | |
| thickness 3 mm | | |
| Foam density of above (g/cm³) | 0.196 | 0.231 |
| 4″ × 4″ Precursor + one 4″ × | | |
| 4″ perforated | | |
| Foam density of above (g/cm³) | 0.13 | 0.172 |

New compositions mixed are based on Exxpro™ 1603 (Isobutylene Copolymer with 4-(bromomethyl) styrene with no unsaturation in main chain) without filler and are shown in Table 3. Very low density materials were obtained without even using a laminate of porous material. OBSH (p,p′-oxybis-(benzenesulfonyl hydrazide) alone at 15 phr level produced foam of density 0.08 g/cm³ while OBSH in combination with Safoam RIC (sodium bicarbonate+citric acid blowing agent available from REEDY Chemical Foam) produced foam of density 0.07 g/cm³. Foam density can be reduced by using combination of blowing agents. It is anticipated that foam density can be further reduced by using a porous laminate of foam precursor (vide infra). In Table 3, Exxpro™ 1603 was initially received from ExxonMobile as developmental sample and the trade name changed to Exxpro™ 3563 after commercialization. Table 3 also shows that by introducing second blowing agent (Safoam RIC) in small amount (2 phr) in composition containing 15 phr main blowing agent (OBSH), density of foam formed is further reduced by 12.5% (0.08 g/cm³ vs 0.07 g/cm³).

TABLE 3
Foam densities formed from compositions based
on Exxpro ™ 1603 without filler

| | 9C024BA | 9C024BB | 9C024DA | 9C024D |
|---|---|---|---|---|
| 1^{st} mixing step | | | | |
| Exxpro ™ 1603/Exxpro ™ | 100 | 100 | 100 | 100 |
| 3563 | | | | |
| Naphthenic oil | | | 10 | 10 |
| ZnO | 1 | 1 | 1 | 1 |
| SP 1045 | 1 | 1 | 1 | 1 |
| Mg-stearate | 1 | 1 | 1 | 1 |
| Duralink HTS | 1 | 1 | 1 | 1 |
| 2^{nd} mixing step | | | | |
| OBSH | 15 | 15 | 15 | 15 |
| Safoam RIC | 0 | 2 | 0 | 2 |

Bladder Molding between nylon films with no
release agent (350° F./12 min/220 psi)

| | | | | |
|---|---|---|---|---|
| Initial Thickness | 0.27 | 0.21 | 0.18 | 0.18 |
| (inches) | | | | |
| Sticking to nylon | No | No | Slight | Slight |
| Density of Cellular | 0.08 | 0.07 | 0.08 | 0.07 |
| material (g/cm³) | | | | |

Passenger tires were built using 9C024DA and 9C024DB cellular precursors. After tire builds, cellular materials formed were removed from tire. Sound absorption coefficients were measured at four frequency ranges using large impedence tube and compared with common polyester polyurethane foam (density 0.024 g/cm³) conventionally glued inside cured tire for cavity noise reduction and are recorded in Table 4.

Primary frequency range which travels inside vehicle cabin causing annoying sound is in the frequency range 200-250 Hz. Table 4 shows that when multiple pores were generated on the skin of the foam facing the cavity, noise absorption exceeded that of polyurethane foam of low density commonly attached inside cured tire. Noise absorptions are also higher at higher harmonic frequency ranges (500-1000 Hz).

This is novel achievement, showing that intrinsic foam of density lower than 0.1 g/cm³ can be generated by applying foam precursor containing less than 20 phr blowing agent in green (uncured) tire as done during conventional tire manufacturing which will reduce cavity noise which is higher than tires with polyurethane foam attached inside tire by cumbersome process after the tire is cured. As used herein, the term intrinsic means the foam noise damper is applied prior to cure, rather than a damper affixed to the tire using an adhesive post-cure. The term intrinsic could also be used as built-in, in-built, or intrgral interchangeably.

TABLE 4
Comparison of sound absorptions of intrinsic
foam vs conventional polyether polyurethane

| | | | Sound Absorption at | | | |
|---|---|---|---|---|---|---|
| | Thickness | Density | Different Frequencies (Hz) | | | |
| Sample | (mm) | (g/cm³) | 200 | 250 | 500 | 1000 |
| Polyether | 19 | 0.024 | 0.05 | 0.07 | 0.14 | 0.36 |
| polyurethane | | | | | | |
| 9C024DA | 18 | 0.09 | 0.04 | 0.05 | 0.13 | 0.37 |
| 9C024DA w/Pores | 18 | 0.09 | 0.08 | 0.09 | 0.19 | 0.39 |
| 9C024DB | 18 | 0.09 | 0.05 | 0.06 | 0.12 | 0.56 |
| 9C024DB w/Pores | 18 | 0.09 | 0.07 | 0.08 | 0.15 | 0.50 |

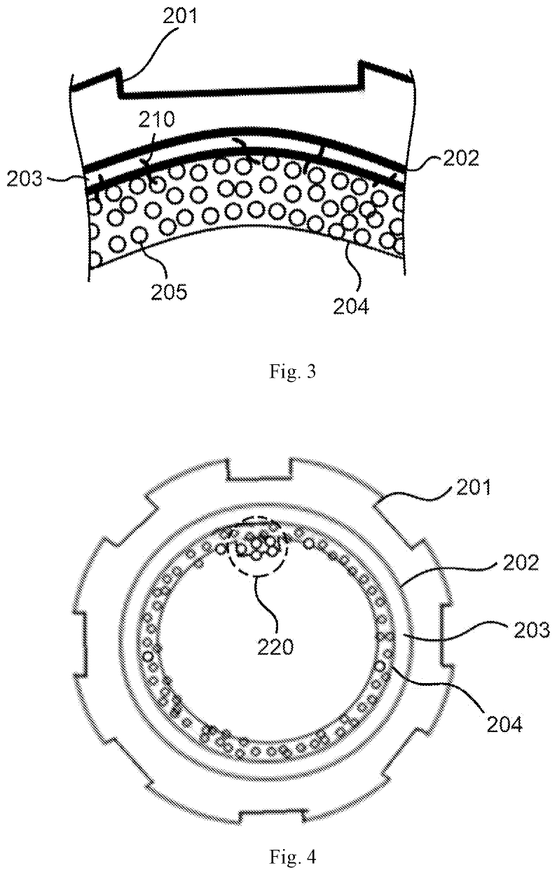

Composition 7C026A and 7C026B shown in Table 2 were scaled up and calendered to 9 cm width and 3 mm thick. Passenger tires (195/60R15 TRIANGLE TR978) were built by applying these precursors in tire building drum. Then, standard tire durability tests were run and results are shown in Table 5. Tires were removed which were not related to intrinsic foam. This shows that innerliner to foam bonding is extremely high due to inter-layer crosslinking (FIG. 3). This opens up the possibility to use wider layer beyond belt edge to tire sidewall for higher noise absorption. Currently, only narrow foam is used underneath innerliner to cured tire with no inter-layer bonding. It cannot be applied even near the belt edge as it will lead to separation of foam from tire.

TABLE 5
Endurance tests of tires where foam precursor is applied in tire building drum

| | # of | | Failed at | | |
|---|---|---|---|---|---|
| Precursor | Layers | ID | Step | h min run | Failure Location |
| 7C026A | 1 | H04134103-032 | 19 | 121′16″ | Both Chafers crack |
| 7C026A | 2 | H04134106-035 | 19 | 121′21″ | Chafer crack at SS |
| 7C026B | 2 | H04134107-036 | 18 | 104″15″ | Chafer crack at NSS |

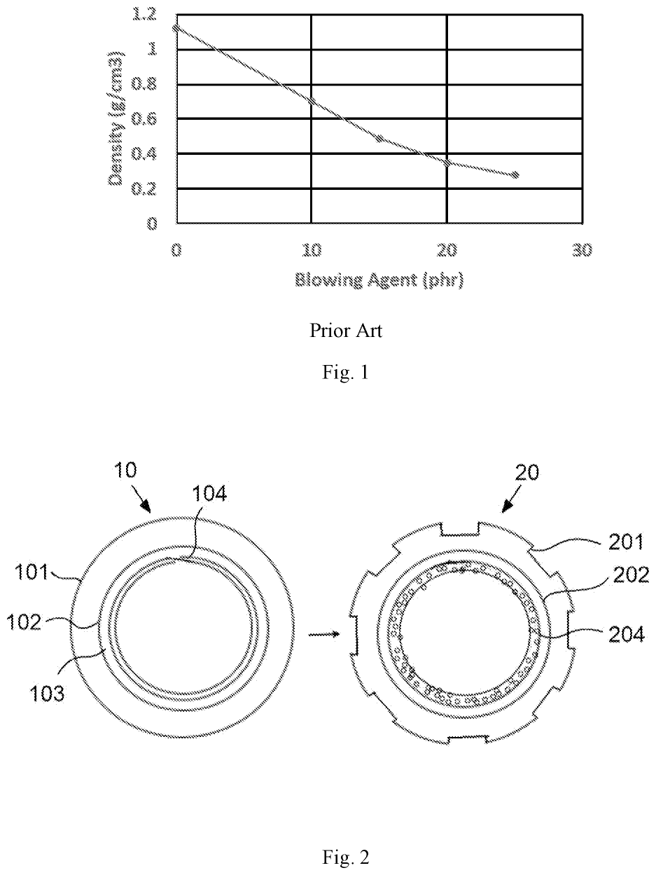

Balance ranking and uniformity ranking of tires built are shown in Table 6. Tires where 2 layers of foam applied in accordance to FIG. 2 were visibly uniform with both uniformity ranking and balance ranking are A. FIG. 2 shows green tire 10 on left and a cured tire 20 on right. The tires contain casing/piles 102 and innerliner 103. It depicts a tire building with two layers of cellular precursor 104 wrapped in such a way so that there is negligible 1-layer or 3-layers at any location in green tire 10 giving rise to tire after cure with no visible non-uniformity within the foam 204. The green/uncured tire 10 has a smooth tread outermost surface 101, while the cured tire 20 has an uneven surface 201 showing lug area (protruding outside) and groove area (protruding inside) from tire curing mold, as well as cured casing/plies 202. (Other layers between casing and tread are not shown as they are not pertinent to the present invention).

Tires are created by joining uncured layers followed by vulcanization for interfacial crosslinking which results in strong bond strength. According to Bohm et al., uncured to cured bond strength is significantly higher than cured to uncured bond strength (212 lbs/inch vs 6 lbs/inch). See G Bohm, L Gia and G Stephanopoulos, “Core rubber recycling problems and new solution”, Paper presented at Tire Technology Expo, Hannover, Germany, Feb. 27, 2020

FIG. 3 shows a closer view of the cross section of a cured tire having interfacial crosslinking 210, which strengthens the bond between the cured innerliner 203 and foam noise damper 204. This interfacial bonding is significantly stronger than any bonding that can be achieved by using an adhesively-affixed noise damper added to a tire after cure. The noise damper 204 includes multiple pores (which can also be referred to as cells or voids) 205.

FIG. 4 shows a tire where 1 layer of foam 204 was applied with slight overlap at ends leading to visibly non-uniformity 220. During tire building with conventional layers overlapping, no significant visible uniformity is observed. Visible uniformity at cellular layer overlap is due to multiple fold expansion after cure and should be avoided at all costs because it is undesirable to customers. However, in a mounted tire, it is not visible for customers to see.

FIG. 5 shows a close up cross section where two precursor layers are used, a first layer 104 as discussed previously, and a second porous layer 105 with holes or perforations 106, and innerliner layer 103. The holes help initial expansion when the mold is closed which is not possible in layers without holes. This gives some room for initial expansion when the molds are closed and final expansion occurs after mold opens This is evident when mold is 90% full in Table 2

TABLE 6
Uniformity ranking (UR) and balance ranking (BR) of tires
Normal production or precursor applied in tire building drum

| Precursor | Layers | Weight | UR | BR |
|---|---|---|---|---|
| None | 0 (Control) | 8.465 | A | B |
| None | 0 (Control) | 8.452 | A | B |
| 7C026A | 1 | 8.643 | B | A |
| 7C026A | 1 | 8.662 | A | A |
| 7C026B | 1 | 8.687 | A | A |
| 7C026B | 1 | 8.669 | B | A |
| 7C026A | 2 | 8.895 | A | A |
| 7C026B | 2 | 9.017 | A | A |

(Note:
Ranking A is better than ranking B)

### Combination of OBSH and Expancel 930DU120 Blowing Agents

Foam precursor composition is shown in Table 7. When this composition was bladder molded with a layer of innerliner, the expansion was so high in all directions that the sample curled-up and could be used for sound absorption tests. In tires, such curl up is not possible as tire casings are strong and rigid.

TABLE 7
Composition of foam precursor with
Combination of Blowing Agents

| | 8C029C |
|---|---|
| 1^{st} Pass | |
| Bromobutyl 2222 | 100 |
| Stanplas 150 | 15 |
| N660 | 26 |
| Zinc Oxide | 1 |
| Stearic Acid | 2 |
| Koresin | 7 |
| 2^{nd} Pass | |
| RM-Sulfur | 0.5 |
| MBTS | 1.3 |
| ZMBT | |
| MBT | 0.65 |
| 3^{rd} Pass | |
| Expancel 930DU120 | 3 |
| OBSH/Celogen OT | 15 |

The following procedure was utilized to keep sample straight so that noise absorption coefficients can be tested from laboratory samples without the need to build tires.

### Bladder Molding with Rigid Metal Mesh Support

6″×6″×0.1″ of 100BIIR-based innerliner was placed on the top of 6 inches diameter wire mesh. Then foam precursors (5″×5″×0.12″ of 8C029C4 were placed on the top of innerliner and then cured in laboratory simulated tire cure in a bladder mold (20 minutes at 350° F./250 psi). Cured laminates did not curl up and remained straight and was used for sound absorption tests.

### Sound Absorption Tests

Metal and innerliner were removed from 8C029C4 samples before sound absorption test. Normal incidence sound absorption tests were run using large tube in the frequency range 100-1600 Hz (ASTM E1050-12) for polyether polyurethane commonly used inside tire and compared with 8C029C4. Sound absorption tests were repeated after punching multiple perforations through the foam skin but not through the entire foam for 8C029C4 sample. Perforations were performed by building a piece of equipment using stapler wire for perforations and were 1 to 5 mm apart in the samples. Sound absorption coefficients in the frequencies 225 Hz, 450 Hz and 675 Hz are shown in Table 8.

TABLE 8
Sound absorption at Different frequencies

| | Sound Absorption at | | |
|---|---|---|---|
| | Different Frequencies | | |
| Sample | 225 Hz | 450 Hz | 675 Hz |
| Polyether polyurethane of density 0.024 | 0.07 | 0.125 | 0.22 |
| g/cm³ | | | |
| 8C029C4 after removal of innerliner and | 0.045 | 0.165 | 0.335 |
| wire mesh | | | |
| Above after multiple surface perforations | 0.075 | 0.04 | 0.25 |

Sound absorption from this foam is lower than control polyurethane foam after perforation at the approximate primary cavity noise frequency range (225 Hz).

### Filler Containing Exxpro™ Based Foam Precursor

Previously, low density foams were generated by lab simulated tire curing in bladder mold to density as low as 0.07 g/cm³ in Exxpro™ based rubber without filler (Table 3). Further reduction in density is expected by creating space for initial expansion as described earlier (FIG. 5). This technique opens up the possibility to prepare foam of very low density intrinsic foam inside tire which is highly desirable in future tires. Thus, composition with 15 phr blowing agent (OBSH) generated foam of density 0.49 g/cm³ (U.S. Pat. No. 7,694,707). Composition similar as U.S. Pat. No. 7,694,707 generated foam of density 73.5% lower i.e. 0.13 g/cm³ when 10% volume was kept for initial expansion during lab simulated tire curing in a bladder mold (7C026A in Table 2). Foam density can further be reduced by optimizing the volume kept for initial expansion during lab simulated tire cure.

Table 9 shows Exxpro-based foam precursor with filler. During bladder molding, it generated low density foam of 0.11 g/cm³. If initial expansion of 10% is created during bladder molding, if that reduces density by 73.5% as before, thus extrapolation shows that foam of density 0.023 g/cm³ can be prepared. Density of 0.023 g/cm³ is even smaller than polyurethane foam conventional glued inside tire (0.24-0.35).

TABLE 9
Exxpro ™ 1603 based foam precursor containing filler

| | 9C034AE |
|---|---|
| Exxpro ™ 1603 | 100 |
| N660 | 26 |
| Naphthenic oil | 10 |
| ZnO | 1 |
| SP 1045 | 1 |
| Mg-stearate | 1 |
| Duralink HTS | 1 |
| 2^{nd} mixing step | |
| OBSH | 15 |
| Safoam RIC | 0.5 |
| Bladder Molding between nylon film | |
| 350° F./220 psi/12 min | |
| Precursor dimensions | 3″ × 3″ × 0.163 |
| Mold Release | Stoner A353 |
| Density (g/cm3) | 0.11 |

Examples shown in Tables 1, 2, 7 and 9 utilized black colored fillers which give rise to black compound with black cellular material. To prevent mix up of cellular precursor with other commonly used black tire compounds, the precursor can be made non-black by using white filler e.g. silica, titanium dioxide and then combined with a non-black color concentrate.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated.

What is claimed is:

1. A tire with intrinsic splice-free cellular noise damper comprising:
a supporting tire carcass having one or more layers of ply, an outer circumferential tread, and a radially inner layer,
a pair of beads,
sidewalls extending radially inward from the axial outer edges of a tread portion to join the respective beads,
an intrinsic cellular noise damper as the innermost layer attached to innerliner, wherein said noise damper has a density less than 1.3 g/cm³.

2. The tire of claim 1, wherein said noise damper has a density of 0.1 g/cm³ or less.

3. The tire of claim 1, wherein said noise damper has a density between 0.02 g/cm³ to 1.2 g/cm³.

4. Tire of claim 1, wherein said noise damper has a non-black color.

5. Tire of claim 1, wherein said noise damper has a black color from carbon black filler.

6. Tire of claim 1, wherein said noise damper has a black color from conductive graphite

7. Tire of claim 1, wherein said noise damper has a black color from conductive black

8. Tire of claim 1, wherein said noise damper is substantially free of any filler

9. Tire of claim 1, wherein said noise damper comprises a rubber selected from halobutyl rubber, bromobutyl rubber, chlorobutyl rubber, butyl rubber, ionic butyl, and ethylene propylene diene monomer, and combinations thereof.

10. The tire of claim 1, wherein said noise damper comprises isobutylene copolymer with 4-(bromomethyl) styrene.

11. The tire of claim 1, wherein said noise damper comprises isobutylene copolymer with 4-(bromomethyl) styrene containing filler selected from graphite, conductive black, carbon black, silica, titanium dioxide, and color pigments, and combinations thereof

12. A method for making a tire having a foam noise damper, the method comprising the steps of:
A. applying at least one layer of noise damper precursor containing less than 20 phr blowing agent to a tire building drum, wherein the ends of the noise damper precursor are first overlapped and then stitched together;
B. applying an innerliner and then other layers commonly used in building pneumatic tires,
C. expanding and shaping the tire,
D. removing from tire building machine; and
E. curing the tire in a tire press.

13. The method of claim 10, wherein two layers of precursors are applied uniformly such that at no place the total thickness of the noise damper layers is less than 2 layers nor more than two layers.

14. The method of claim 10, wherein three layers of precursors are applied uniformly such that at no place the total thickness of the noise damper layers is less than 3 layers nor more than three layers.

15. The method of claim 10, wherein four layers of precursors are applied uniformly such that at no place the total thickness of the noise damper layers is less than 4 layers nor more than four layers.

16. The method of claim 10, wherein two layers of precursors are applied, wherein a first precursor layer is applied with the ends touching, then a second precursor layer is applied with the ends touching, starting at 180 degrees from the two touched ends of the first layer, wherein said first layer is non-porous and sticks to building drum, wherein said second layer is porous, wherein touched ends of the first layer and situated 180 degree apart from the touched ends of the second layer.
